(19) United States
(12) Patent Application Publication
(10) Pub. No.: US 2011/0079560 A1
(43) Pub. Date: Apr. 7, 2011

(54) CATALYTIC WET OXIDATION SYSTEMS AND METHODS

(75) Inventors: Clayton B. Maugans, Wausau, WI (US); Bryan J. Kumfer, Wausau, WI (US); Chad L. Felch, Mosinee, WI (US); William M. Copa, Weston, WI (US)

(73) Assignee: SIEMENS WATER TECHNOLOGIES CORP., Warrendale, PA (US)

(21) Appl. No.: 12/935,271

(22) PCT Filed: Apr. 3, 2009
(86) PCT No.: PCT/US09/02105

§ 371 Date: Dec. 13, 2010

Related U.S. Application Data
(60) Provisional application No. 61/042,120, filed on Apr. 3, 2008.

(51) Int. Cl. C02F 1/72

(52) U.S. Cl. 210/763; 210/206

(57) ABSTRACT

A system and method for the treating at least one undesirable constituent in an aqueous mixture utilizing a particulate solids catalyst. The aqueous mixture and the particulate solids catalyst form a slurry which is wet oxidized.

### BACKGROUND OF THE INVENTION

1. Field of the Invention

The present invention relates to the treatment of waste streams and/or process streams and, more particularly, to catalytic wet oxidation systems and methods for treatment of undesirable constituents therein.

2. Background Information

Wet oxidation is a well-known technology for treating process streams, and is widely used, for example, to destroy pollutants in wastewater. The method involves aqueous phase oxidation of undesirable constituents by an oxidizing agent, generally molecular oxygen from an oxygen-containing gas, at elevated temperatures and pressures. The process can convert organic contaminants to carbon dioxide, water and biodegradable short chain organic acids, such as acetic acid. Inorganic constituents including sulfides and mercaptides can also be oxidized.

As an alternative to incineration, wet oxidation may be used in a wide variety of applications to treat process streams for subsequent discharge, in-process recycle, or as a pretreatment step to supply a conventional biological treatment plant for polishing. Catalytic wet oxidation has emerged as an effective enhancement to traditional non-catalytic wet oxidation.

### SUMMARY OF THE INVENTION

In accordance with one or more embodiments, the invention relates to a catalytic wet oxidation system and process. The process may comprise providing an aqueous mixture comprising at least one undesirable constituent to be treated and contacting the aqueous mixture with a particulate solids catalyst to form a slurry mixture. The slurry is oxidized at a subcritical temperature and a superatmoshperic pressure to treat the at least one undesirable constituent and form an oxidized slurry mixture. A particulate solids catalyst is separated from the oxidized slurry mixture.

Another embodiment is directed to a catalytic wet oxidation system having a wet oxidation unit, a source of an aqueous mixture comprising at least one undesirable constituent fluidly connect to a feed inlet of the wet oxidation unit, and an aqueous mixture conduit comprising an inlet fluidly connected to an outlet of the source of the aqueous mixture; and an outlet fluidly connected to the feed inlet of the wet oxidation unite. The system also comprises a source of particulate solids catalyst, insoluble in the aqueous mixture, fluidly connected to at least one of a catalyst inlet of the wet oxidation unit, the source of the aqueous mixture, and the aqueous mixture conduit. The system also includes a separator comprising an inlet fluidly connected to an outlet of the wet oxidation unit and a catalyst slurry outlet fluidly connected to at least one of the catalyst inlet to the wet oxidation unit, the source of the aqueous mixture, and the aqueous mixture conduit.

In some embodiments, the particulate solids catalyst is selected from the group consisting of a transition metal element and water insoluble compounds thereof. In other embodiments, the particulate solids catalyst comprises at least two transition metal elements including water insoluble compounds thereof, such as manganese oxide and cerium oxide.

Other advantages, novel features and objects of the invention will become apparent from the following detailed description of the invention when considered in conjunction with the accompanying drawings.

### BRIEF DESCRIPTION OF THE DRAWINGS

The accompanying drawings are not intended to be drawn to scale. In the drawings, each identical, or substantially similar component is represented by a single numeral or notation. For purposed of clarity, not every component is labeled in every figure, nor is every component of each embodiment of the invention shown where illustration is not necessary to allow those of ordinary skill in the art to understand the invention. Preferred, non-limiting embodiments of the present invention will be described by way of example and with reference to the accompanying drawings, in which:

FIG. 1 is a generalized flow scheme of a wet oxidation system employed to carry out the process of the present invention;

FIG. 2 is a flow scheme of a wet oxidation system employed to carry out one embodiment of the process of the present invention;

FIG. 3 is a flow scheme of a wet oxidation system employed to carry out another embodiment of the process of the present invention; and

FIG. 4 is a flow scheme of a wet oxidation system employed to carry out yet another embodiment of the process of the present invention.

### DETAILED DESCRIPTION

The present invention of relates to the catalytic wet oxidation of a waste stream and/or process stream utilizing a suspended particulate solids catalyst. Wet oxidation is a well-known technology for the destruction of pollutants in wastewater involving the treatment of the waste stream with an oxidant, generally molecular oxygen from an oxygen-containing gas, at elevated temperatures and pressures. Wet oxidation at temperatures below the critical temperature of water, 374° C., is termed subcritical wet oxidation. Subcritical wet oxidation systems operate at sufficient pressure to maintain a liquid water phase and may be used commercially for conditioning sewage sludge, the oxidation of caustic sulfide wastes, regeneration of powdered activated carbon, and the oxidation of chemical production wastewaters, to name only a few applications. Catalytic wet oxidation may result in cost savings, in particular reduce energy costs, when compared to conventional wet oxidation in that acceptable treatment levels may occur at reduced temperatures, pressures, and/or reaction times. Alternatively, catalytic wet oxidation may result in higher treatment levels when compared to conventional wet oxidation.

In accordance with one or more embodiments, the invention relates to one or more systems and methods for treating process streams. In typical operation, the disclosed systems may receive process streams from community, industrial or residential sources. For example, in embodiments in which the system is treating wastewater, the process stream may be delivered from a municipal wastewater sludge or other large-scale sewage system. Process streams may also originate, for example, from food processing plants, chemical processing facilities, gasification projects, or pulp and paper plants. The process stream may be moved through the system by an operation upstream or downstream of the system.

As used herein, the term “process stream” refers to an aqueous mixture deliverable to the system for treatment. After treatment, the process stream may be returned to an upstream process or may exit the system as waste. The aqueous mixture typically includes at least one undesirable constituent capable of being oxidized. The undesirable constituent may be any material or compound targeted to be removed from the aqueous mixture, such as for public health, process design and/or aesthetic considerations. In some embodiments, the undesirable constituents capable of being oxidized are organic compounds. Certain inorganic constituents, for example, sulfides and mercaptides may also be oxidized. A source of an aqueous mixture to be treated by the system may take the form of direct piping from a plant or holding vessel. In one embodiment, the aqueous mixture may comprise at least one of an organic acid compound, a phenolic compound, an organic halogen compound, a nitrogen-containing compound and a sulfur containing compound.

In accordance with one or more embodiments of the present invention, it is desirable to disrupt one or more specific chemical bonds in the undesirable constituent or degradation product(s) thereof. One aspect of the present invention involves systems and methods for oxidative treatment of aqueous mixtures containing one or more undesirable constituents.

In one embodiment, an aqueous mixture including at least one undesirable constituent is wet oxidized. The aqueous mixture is oxidized with an oxidizing agent at an elevated temperature and superatmospheric pressure for a duration sufficient to treat the at least one undesirable constituent. The oxidation reaction may substantially destroy the integrity of one or more chemical bonds in the undesirable constituent. As used herein, the phrase “substantially destroy” is defined as at least about 95% destruction. The process of the present invention is generally applicable to the treatment of any undesirable constituent capable of being oxidized.

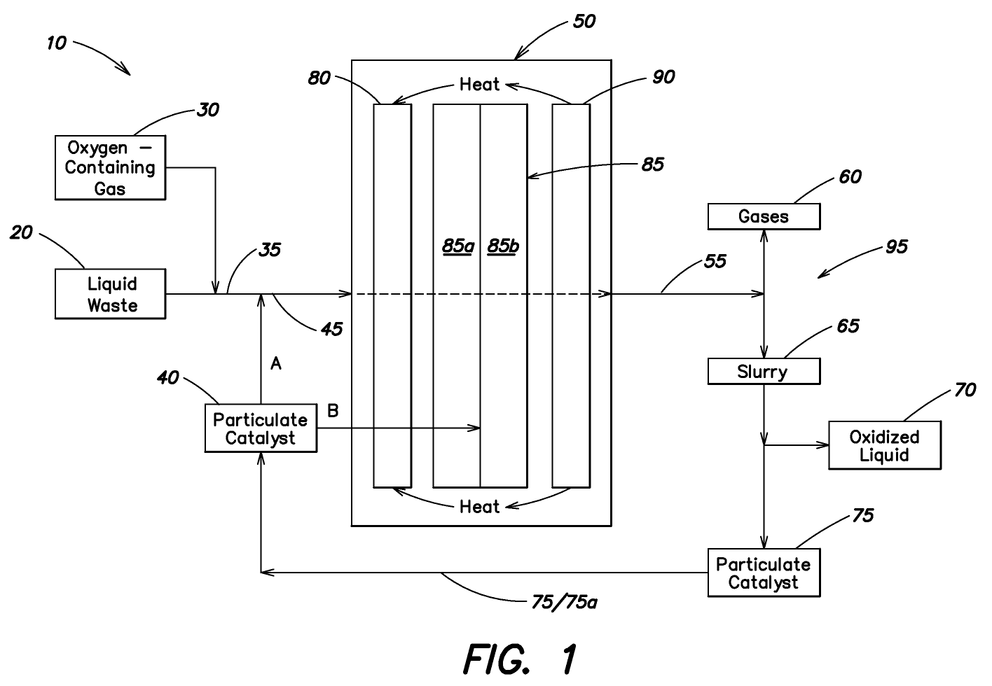

The disclosed wet oxidation processes may be performed in any known batch or continuous wet oxidation unit suitable for the compounds to be oxidized. Typically, aqueous phase oxidation is performed in a continuous flow wet oxidation system, as exemplarily shown in FIG. 1. Any oxidizing agent may be used. The oxidant is usually an oxygen-containing gas, such as air, oxygen-enriched air, or essentially pure oxygen. As used herein, the phrase “oxygen-enriched air” is defined as air having an oxygen content greater than about 21%.

In one embodiment the aqueous mixture including at least one undesirable constituent is contacted with a particulate solids catalyst. The particulate solids catalyst may be any heterogeneous catalyst insoluble or substantially insoluble in the aqueous mixture and is suitable to treat the one or more undesirable constituents in the aqueous mixture. As used herein, the phrase “substantially insoluble catalyst” refers to a solid catalyst whose solubility in water is less than 3% by weight. Heterogeneous catalysts known effective in wet oxidation systems may be used when in slurry form. As used herein, the term slurry is defined as a suspension of insoluble particles in a liquid carrier. The liquid carrier may be any liquid suitable for a particular purpose which does not appreciably solubilize the particles. In one embodiment, the liquid may be water. The particulate solids catalyst may be supported on any fluidizable media, such as spheres and microspheres, which when added to the aqueous mixture form an aqueous slurry.

In one embodiment, the catalyst may remain substantially insoluble in the aqueous mixture during wet oxidation. The particulate solids catalyst may be sufficiently small in size to remain in the aqueous slurry as it flows through the wet oxidation system and may have sufficient density to be separated from an oxidized slurry mixture. In one embodiment, the particulate solids catalyst may have a particle size ranging from about 5 microns to about 500 microns to provide suitable settling characteristics. In another embodiment, the solids particulate catalyst may comprise nanometer size particles of a metal, metal oxide, and/or a metal salt. The nanometer size particulate solids catalyst may comprise discrete particles ranging from about 3 nanometers to about 15 nanometers and/or agglomerated particles having a size ranging from about 10 nanometers to about 500 nanometers.

In one embodiment, the particulate solids catalyst may be a metal element and/or its compound such as a metal oxide and/or a metal salt in particulate form or on a fluidizable inert support carrier. In another embodiment, the catalyst comprises at least two metal elements and/or their compounds. In yet another embodiment, the catalyst comprises two transition metals and/or noble metal so that the catalyst may comprise at least two transition metals, at least one transition metal and at least one noble metal, or at least two noble metals. The at least two metals may take the form of a mixture and/or a reaction product of the at least two metals. In one embodiment, the particulate solids catalyst may be one or more metals, metal oxides, and metal salts.

Suitable metals include the first transition series including atomic numbers ranging from 21-30 and more specifically, scandium, titanium, vanadium, chromium, manganese, iron, cobalt, nickel, copper, and zinc. Suitable metals also include the second transition series including atomic numbers ranging from 39-28, and more specifically, yttrium, zirconium, niobium, molybdenum, technetium, ruthenium, rhodium, palladium, silver, and cadmium. Suitable metals also include the third transition series including atomic numbers ranging from 72-80, and specifically including, hafnium, tantalum, tungsten, rhenium, osmium, iridium, platinum, gold, and mercury. Other suitable metals include metals from the lanthanide series including atomic numbers ranging from 57 to 71, and more specifically, lanthanum, cerium, praseodymium, neodymium, promethium, samarium, europium, gadolinium, terbium, dysprosium, holmium, erbium, thulium, ytterbium, lutetium. The noble metals are included in the transition metals and include palladium, silver, platinum and gold.

In one embodiment, the particulate solids catalyst comprises manganese oxide. In another embodiment, the particulate solids catalyst comprises cerium oxide. In yet another embodiment, the particulate solids catalyst comprises a mixture of manganese oxide and cerium oxide in a ratio of about 70:30 mol % Mn:Ce.

In one embodiment, the catalyst may be added to the aqueous mixture prior to entering a wet oxidation unit and/or may be directly added to aqueous mixture in the wet oxidation unit thereby forming an aqueous slurry. An effective amount of catalyst may be generally sufficient to increase reaction rates and/or improve the overall destruction removal efficiency of the system, including enhanced reduction of chemical oxygen demand (COD). The catalyst may also serve to lower the overall energy requirements of the wet oxidation system.

The freely flowing heterogeneous catalyst of one embodiment is advantageous over conventional heterogeneous catalysts which remain in the oxidation. Unlike conventional uses of heterogeneous catalysts in wet oxidation units which employ stationary beds, contained fluidized beds or similar fixed architectures such as honeycombs, the particulate solids catalyst of the present invention may be carried throughout all portions of a wet oxidation system and may be recycled without the need to interrupt the catalytic wet oxidation process. Because the free flowing heterogeneous catalyst comprises particles in a slurry mixture, the particulate solids catalyst is in intimate contact with the at least one undesirable constituent in the aqueous mixture. Moreover, the heterogeneous catalyst is continuously removed from the wet oxidation unit along with the oxidized slurry so that spent heterogeneous catalyst is continuously removed and replaced with fresh catalyst without the need to take the wet oxidation unit out of service in order to replace or regenerate the heterogeneous catalyst. Conventional packed or fluidized catalysts beds are also subject to plugging by solids contained in the aqueous mixture or formed during wet oxidation treatment, catalyst particle disintegration, undesirable pressure drops and catalyst loss from the bed. The spent heterogeneous catalyst according to one embodiment may be separated from the oxidized slurry mixture, regenerated if desired, and returned upstream to the aqueous mixture in or entering the wet oxidation unit, thereby reducing the raw material costs and eliminating or substantially reducing plugging, pressure drops, particle disintegration and catalyst loss from the wet oxidation unit.

The particulate solids catalyst may be separated from the oxidized slurry mixture by conventional means, such as gravity settling of solids in a quiescent area, or various separation processes, such as centrifugation, membrane filtration, hydrocyclones, and the like, which produce a recovered particulate solids catalyst, which may but need not be in slurry form. The physical separation of the heterogeneous catalyst from the oxidized slurry mixture of one embodiment may be advantageous in that it may be less difficult and less expensive than removing conventional homogenous catalysts solubilized in an oxidized effluent.

In one embodiment, the aqueous slurry comprising the at least one undesirable constituent and the particulate solid catalyst is heated prior to entering and/or within a heated reaction zone to an elevated temperature and at a pressure sufficient to maintain a portion of the catalyst suspension mixture in the liquid phase, for a time sufficient to oxidize and treat the at least one undesirable constituent and form an oxidized slurry mixture. The oxidized slurry mixture is then withdrawn from the reaction zone and cooled to a temperature substantially below the elevated temperature of the reaction zone. The cooled oxidized slurry mixture is depressurized to produce an off-gas phase and an oxidized effluent liquid phase. The off-gas phase is vented to the atmosphere or to a further treatment step. Optionally, the oxidized effluent liquid phase is treated to form a recovered particulate solids catalyst, which may be in the form of a slurry, and an oxidized effluent liquid phase, which is substantially free of particulate solids catalyst. At least a portion of the recovered particulate solids catalyst is recycled in order to form additional catalyst suspension feed mixture. At least a portion of the recovered particulate solids catalyst may be treated to remove inert solid particulates there from and/or regenerate the catalyst prior to being directed to the aqueous mixture upstream of and/or in the wet oxidation unit.

FIG. 1 is a schematic of a wet oxidation system 10 according to one embodiment of the invention. A process stream 20 containing a first concentration of one or more undesirable constituents may be directed to wet oxidation reaction zone 50 via line 25 to produce a treated effluent 70 containing a second concentration of the one or more undesirable constituents less than the first. Oxygen containing gas 30 may be directed to the wet oxidation reaction zone 50 via line 31 to form an oxidation feed mixture 35. Alternatively, or in addition to combining the oxygen-containing gas and the process stream in line 25, the oxygen containing gas may be fed directly to wet oxidation unit 85.

A particulate solids catalyst 40 may be added to the aqueous mixture at any point in the wet oxidation system. Particulate solids catalyst 40 may be added to the oxidation feed mixture 35 to form an aqueous slurry feed mixture 45 denoted in FIG. 1 as route A. In one embodiment, the catalyst may be added to the source of the aqueous mixture feeding the wet oxidation unit as illustrated in FIG. 1 in which catalyst source 40 is fluidly connected to storage tank 10. In addition to or alternatively, the particulate solids catalyst 40 may be added to the process stream 20 prior to combining with an oxygen-containing gas 30 to form the aqueous slurry feed mixture 45. In yet another embodiment, the particulate solids catalyst 40 may be directly added to the wet oxidation section 85, denoted as route B.

The aqueous slurry feed mixture 45 may pass through a contained reaction zone 50, at an elevated temperature less than about 374° C. and elevated pressure sufficient to maintain a portion of the aqueous slurry feed mixture 45 in a liquid phase, to treat a portion of the one or more undesirable constituents to form an oxidized slurry mixture 55. The oxidized slurry mixture 55 may be separated into a gas phase 60 and an oxidized slurry phase 65. In a further embodiment of the process, the oxidized slurry phase 65 may be separated into an oxidized liquid phase 70 and a particulate solids catalyst phase 75, which may be in the form of a slurry.

As shown in FIG. 1, oxidation reaction zone 50 may comprise a heating section 80 to elevate the temperature of the various feed mixtures, 25, 35 or 45, a wet oxidation section 85 providing a desired hydraulic retention time for the various feed mixtures, 25, 35 or 45, within the oxidation reaction zone 50, and a cooling section 90 to lower the temperature of the oxidized slurry mixture 55. In one embodiment, the oxidation reaction zone 50 may be configured so that heat removed from the oxidized slurry mixture 55 in the cooling section 90 may be transferred to the heating section 80 to heat the incoming feed mixtures, 25, 35 or 45, thereby improving the energy efficiency of the wet oxidation system 10.

In a further embodiment of the process, the oxidation reactor section 85 may include at least two reactor portions, 85a, 85b. In this embodiment, at least a portion of the particulate solids catalyst 40 may be added to the oxidation feed mixture 35 downstream of the first reactor portion 85a, via route B in FIG. 1. The at least two reactor portions 85a, 85b may, but need not be operated under identical temperatures and pressures.

In one embodiment, the wet oxidation process may be operated at a temperature below 374° C., the critical temperature of water. In one embodiment, the wet oxidation process may be operated at a temperature between about 150° C. and about 373° C. In another embodiment, the wet oxidation process may be operated at a temperature between about 150° C. and about 320° C. The retention time for the aqueous slurry mixture at the selected oxidation temperature is at least about 15 minutes and up to about 6 hours. In one embodiment, the aqueous slurry mixture is oxidized for about 15 minutes to about 4 hours. In another embodiment, the aqueous slurry mixture is oxidized for about 30 minutes to about 3 hours.

Sufficient oxygen-containing gas may be supplied to the system to maintain an oxygen residual in the wet oxidation system offgas, and the gas pressure is sufficient to maintain water in the liquid phase at the selected oxidation temperature. For example, the minimum pressure at 240° C. is 33 atmospheres, the minimum pressure at 280° C. is 64 atmospheres, and the minimum pressure at 373° C. is 215 atmospheres. In one embodiment, the aqueous slurry mixture is oxidized at a pressure of about 10 atmospheres to about 275 atmospheres. In another embodiment, the aqueous slurry mixture is oxidized at a pressure of about 10 atmospheres to about 217 atmospheres.

In one embodiment of the process, the oxidized slurry mixture 55 may be separated into a gas phase 60, an oxidized liquid phase 70 and a particulate solids catalyst phase 75, simultaneously, in a separation zone 95. In an alternative embodiment of the process, the oxidized slurry mixture 55 may be separated into a gas phase 60, an oxidized liquid phase 70 and a particulate solids catalyst phase 75 in multiple separation zones 95, in which the gas phase 60 may be separated from the oxidized slurry mixture 55 prior to separating the oxidized liquid phase 70 from the particulate solids catalyst phase 75.

In yet a further embodiment of the process, at least a portion of the particulate solids catalyst phase 75 may be recycled to the oxidation reactor section 85 and/or to any point upstream of the oxidation reactor section 85 to form the aqueous slurry mixture 45. Prior to being recycled, the particulate solids catalyst phase 75 may be treated to remove inert solid particulates there from to form a recovered particulate solids catalyst phase 75a, which may be recycled to the oxidation reactor section 85 to form the aqueous slurry mixture 45.

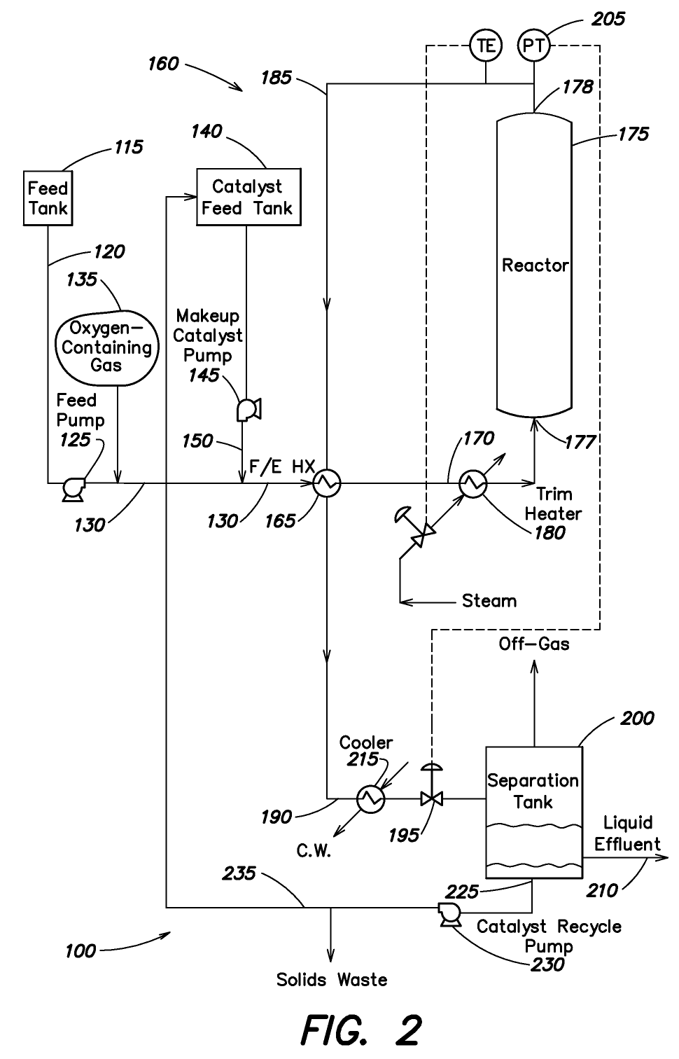

Referring now to FIG. 2, a schematic representation of a wet oxidation system used for carrying out one embodiment of the process of the present invention is shown. The wet oxidation system 100 includes a feed tank 115, containing the aqueous mixture comprising at least one undesirable constituent. The aqueous mixture flows through a conduit 120 to a feed pump 125 which delivers the aqueous mixture to the wet oxidation system 100 at system operating pressure. The pressurized aqueous mixture in a conduit 130 is mixed with an oxygen-containing gas from a pressurized gas source 135 to form an oxidation aqueous mixture, comprising a gas phase and a liquid phase. The oxygen-containing gas includes air, oxygen-enriched air, or essentially pure oxygen gas. A particulate solids catalyst is added to the oxidation aqueous mixture to form an aqueous slurry mixture. The particulate solids catalyst may be prepared as a slurry in the catalyst feed tank 140 prior to injection into the oxidation aqueous mixture. The particulate solids catalyst may be added to the pressurized oxidation feed mixture by means of a pump 145 delivering the particulate solids catalyst to the oxidation aqueous mixture in the conduit 130, via a conduit 150. The particulate solids catalyst and the aqueous mixture form an aqueous slurry mixture. In one embodiment the aqueous slurry mixture moves with sufficient velocity through the conduit 130 to prevent or reduce settling of the catalyst particles.

In addition or alternatively, the particulate solids catalyst may be added to the feed tank 115, containing the aqueous mixture containing the at least one undesirable constituent at ambient pressure, prior to mixing with an oxygen-containing gas from the pressurized gas source 135 to form an oxidation slurry mixture.

The aqueous slurry mixture is then heated in a reaction zone 160 to an elevated temperature and at a pressure sufficient to maintain a portion of the aqueous slurry mixture in the liquid phase, for a time sufficient to treat the at least one undesirable constituents thereby forming an oxidized slurry mixture.

In this embodiment of the process, the reaction zone 160 includes a process heat exchanger 165 that transfers heat from the oxidized slurry mixture withdrawn from the reaction zone 160 to the aqueous slurry mixture entering the reaction zone 160. Oxidation of the one or more undesirable constituents by oxygen of the oxygen-containing gas is exothermic, thereby raising the temperature in the reaction zone 160 to a selected value. In one embodiment, the elevated temperature of the reaction zone ranges from about 90° C. to about 370° C. The operating pressure of the wet oxidation system 100 is sufficient to maintain a portion of the aqueous slurry mixture in the liquid phase and prevent the reaction zone 160 from drying out. Operating pressures may range form between about 0.3 MPa to about 30 MPa. The partially heated aqueous slurry mixture flows from the process heat exchanger 165, via a conduit 170, to the wet oxidation reactor 175 which provides the desired residence time for the bulk of the oxidation of the at least one undesirable constituents in the aqueous slurry mixture to occur. Should the concentration of oxidizable undesirable constituents in the aqueous slurry mixture be insufficient to heat the feed mixture to the desired reactor temperature selected, a supplemental trim heater 180 may be utilized in the conduit 170 to provide additional energy to raise the aqueous slurry mixture temperature. The trim heater 180 may also be used to elevate the temperature of the aqueous slurry mixture during startup of the wet oxidation system 100.

The wet oxidation unit may be any conventional unit. For example the wet oxidation unit may be made of steel, nickel, chromium, titanium, and combinations thereof. The wet oxidation reactor 175 may have any configuration suitable for its intended purpose. The reactor 175 may be a vertical cylindrical vessel having a feed or reactor inlet 177 at or near the bottom of the reactor vessel 175 and a reactor outlet 178 at or near the top of the reactor vessel 175. In one embodiment, suspension of the particulate solids catalyst in the reactor vessel 175 may be augmented with a suspension system incorporated into the reactor vessel 175. The suspension system may include one or more of conventional mechanical mixers, gas suspension systems and counter current flow configurations.

Upon leaving the reactor 175 via a conduit 185, the oxidation of undesirable constituents may be substantially complete. The oxidized slurry mixture is then withdrawn from the reaction zone 160 and cooled to a temperature substantially below the elevated temperature of the reaction zone 160. To cool, the oxidized slurry mixture flows via the conduit 185 through the process heat exchanger 165 that transfers heat from the oxidized slurry mixture withdrawn from the contained reaction zone 160 to the aqueous mixture or oxidation slurry mixture entering the contained reaction zone 160.

The cooled oxidized slurry mixture flows via a conduit 190 to a pressure control valve 195 fluidly connected to a separation tank 200. Optionally, the oxidized slurry may pass through an additional cooling device 215 to remove additional heat energy from the oxidized slurry mixture before reaching the pressure control valve 195. The cooling device 215 may include a conventional heat exchanger utilizing cool fluid, such as water. The pressure control valve 195 may be in electronic communication with a pressure transducer 205 which monitors system pressure in the effluent conduit 185 adjacent the top of the reactor 175. The cooled oxidized slurry mixture may be depressurized via passage of the oxidized slurry mixture through the pressure control valve 195 and directed into the separation tank 200 to produce an off-gas phase and an oxidized effluent liquid phase containing the catalyst suspension. The off-gas phase is vented from the separation tank 200 to the atmosphere or to a further treatment step. The oxidized effluent liquid phase containing the suspended particulate solids catalyst may then be treated to form a recovered particulate solids catalyst phase and an oxidized effluent liquid phase which is substantially free of particulate solids catalyst.

The particulate solids catalyst may be separated from the oxidized slurry mixture by any conventional processes. In the embodiment shown in FIG. 2, the catalyst separation treatment system includes gravity settling to separate catalyst particles phase from oxidized liquid effluent. Other suitable liquid/solid separation devices, such as a centrifuge, can function to effect separation of catalyst solids phase from oxidized liquid. The liquid effluent may be drawn off of the separation tank 200 via an effluent conduit 210. The oxidized liquid effluent is substantially free of catalyst particles and can be discharged to the environment or subjected to further treatment if desired.

At least a portion of the recovered particulate solids catalyst phase may be recycled in order to form additional aqueous slurry mixture for wet oxidation. In FIG. 2, the settled particulate solids catalyst in the form of a slurry exits the separation tank 200 through a conduit 225. The catalyst solids are delivered with a catalyst slurry recycle pump 230 via a conduit 235 to the conduit 130 for addition to the pressurized oxidation slurry mixture therein. The recycled catalyst slurry may supplement the particulate solids catalyst added to the aqueous mixture or to the oxidation aqueous mixture to form a slurry mixture. After initial charging of the system with particulate solids catalyst, sufficient recovered catalyst may be available from the catalyst recycle section to satisfy all or substantially all the catalyst desired for addition to the aqueous mixture or the oxidation aqueous mixture flowing through the conduit 130 and entering the reaction zone 160. Alternatively, the oxidized effluent slurry phase containing the catalyst suspension may be discharged if recovery of the catalyst particles is not desired. The cost of the catalyst particles may be sufficiently inexpensive that recovery is not economically viable. If recovery of the catalyst particles is desired either because of the high cost of the solid particulate catalyst or discharge is regulated by one or more government agencies then the particulate solids catalyst may be separated and recovered for reuse. In another embodiment, the recovered particulate solids catalyst phase may be treated to remove inert solid particulates there from prior to being recycled for wet oxidation.

In one embodiment, the particulate solids catalyst can be poisoned or otherwise rendered ineffective by other constituents in the aqueous mixture which deactivate active sites on the heterogeneous catalyst before the one or more undesirable constituents can be treated by the wet air oxidation reaction. To prevent or reduce the level of deactivation of the heterogeneous catalyst, the catalytic wet air oxidation process may proceed in two stages. The aqueous mixture may be initially oxidized in a first stage without the addition of the particulate solids catalyst. A particulate solids catalyst may then be added to the partially oxidized aqueous mixture so that catalytic oxidation may occur in a second stage. In the first stage, complex organic structures may be oxidized to produce simple more refractory organic compounds (e.g., acetic acid). Any reduced sulfur compounds in the aqueous mixture may also be oxidized in the first stage thereby destroying their catalyst poisoning tendencies. In the second stage, the resulting refractory organic compounds may be catalytically oxidized allowing the second stage catalytic wet air oxidation process to produce an oxidized effluent that is environmentally suitable for discharge directly to a surface water body. Operating the catalytic wet air oxidation process according to the above two stage flow scheme may eliminate or substantially reduce poisoning of the particulate solids catalyst by constituents in the untreated wastewater or process stream and produces a high quality oxidized effluent. The heterogeneous particulate solids catalyst can be recovered from the oxidized effluent in the form of a slurry and recycled to the second stage of the two stage catalytic wet air oxidation process.

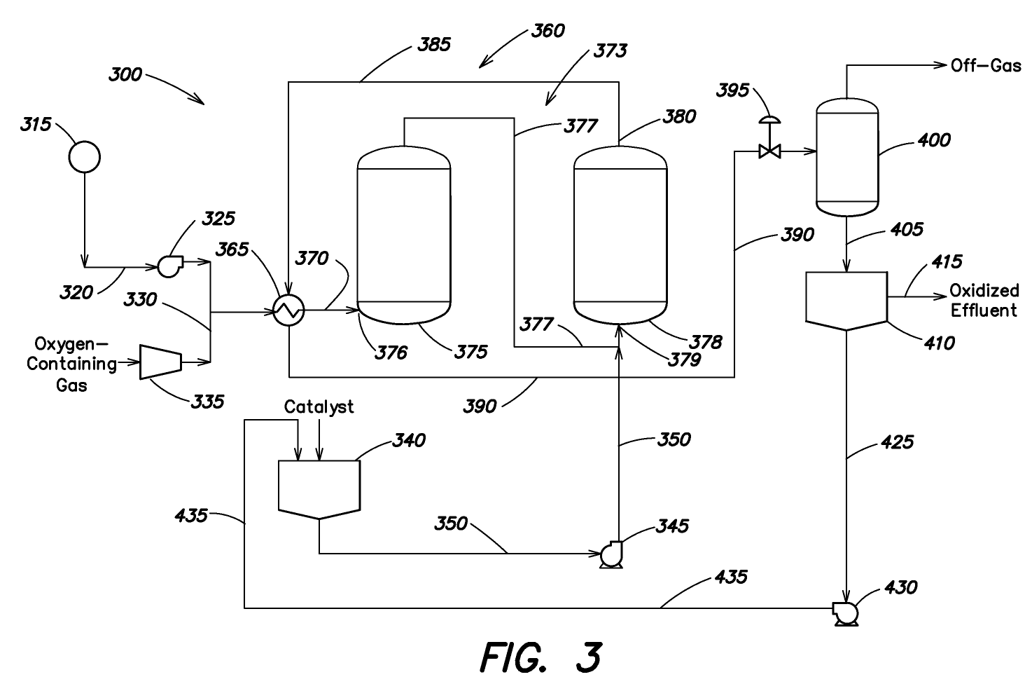

FIG. 3 is a schematic representation of a two-stage wet oxidation system. The wet oxidation system 300 includes a feed tank 315 containing the aqueous mixture comprising one or more undesirable constituents to be treated. The aqueous mixture flows through a conduit 320 to a feed pump 325 which delivers the aqueous mixture to the wet oxidation system 300 at system operating pressure. The pressurized aqueous mixture in a conduit 330 is mixed with an oxygen-containing gas from a pressurized gas source 335 to form an oxidation aqueous mixture comprising a gas phase and a liquid phase. The oxygen-containing gas includes air, oxygen-enriched air, or essentially pure oxygen gas. Following injection of the oxygen-containing gas from the pressurized gas source 335, the oxidation aqueous mixture is heated in a reaction zone 360 to an elevated temperature and at a pressure sufficient to maintain at least a portion of the oxidation aqueous mixture in the liquid phase for a time sufficient to oxidize a portion of the one or more undesirable constituents to form oxidized slurry effluent. In this embodiment, the reaction zone 360 includes at least two wet oxidation reactors 375, 378 in series, which provide the residence time for the bulk of the oxidation of the one or more undesirable constituents in the oxidation aqueous mixture to occur.

The reaction zone 360 may include a process heat exchanger 365 that transfers heat from the oxidized slurry effluent withdrawn from the second oxidation reactor 378 and departing the reaction zone 360 to the aqueous mixture or oxidation aqueous mixture entering the reaction zone 360. Oxidation of the at least one of the one or more undesirable constituents in the aqueous mixture by oxygen of the oxygen-containing gas is exothermic, thereby raising the temperature in the reaction zone 360 to a selected value. The elevated temperature of the reaction zone may range from between about 90° C. to about 370° C. The operating pressure of the wet oxidation system 300 is sufficient to maintain at least a portion of the oxidation feed mixture in the liquid phase and prevent the reaction zone 360 from drying out. The operating pressure of the system may range from between about 0.3 MPa to about 30 MPa. The partially heated oxidation aqueous mixture flows from the process heat exchanger 365 via a conduit 370 to the first oxidation reactor 375 which provides the residence time for a portion of the oxidation of the one or more undesirable constituents oxidation aqueous mixture to occur thereby forming one or more undesirable intermediate constituents. Alternatively, or in addition, other constituents having a potential for contaminating a selected heterogeneous catalyst may be substantially oxidized.

The oxidized effluent exiting the first oxidation reactor 375 passes to a second oxidation reactor 378 via conduit 377 and second reactor inlet 379 to further oxidize the one or more undesirable intermediate constituents. In addition, or alternatively, the previously oxidized other constituents having the potential to contaminate the selected heterogeneous catalyst may be further oxidized. At the inlet 379 to the second reactor 378, a slurry of particulate solids catalyst is combined with the partially oxidized mixture to catalyze further oxidation of undesirable constituents. The particulate solids catalyst is prepared as a slurry in the catalyst feed tank 340 and may be added to the pressurized system by means of a catalyst pump 345 via a conduit 350. The catalyst pump 345 delivers the catalyst to the partially oxidized feed mixture in the conduit 377 as the partially oxidized feed mixture enters the second reactor 378 via the inlet 379. The partially oxidized aqueous slurry moves with sufficient velocity through the conduit 350 to prevent or reduce settling of the catalyst particles. The particulate solids catalyst and additional hydraulic detention time in the second oxidation reactor 378 provides further oxidation of the one or more undesirable constituents.

The reactors 375, 378 may, but need not be operated under similar or identical conditions, such as temperature and pressure and may, but need not, have similar or identical configurations. In one embodiment, each reactor 375, 378 are vertical cylindrical vessels with the reactor inlets 376, 379 at or near the bottom of the reactor vessels 375, 378, respectively, and the reactor outlets 377, 380 at or near the top of the reactor vessel 375, 378, respectively. In an alternative embodiment, a portion of the oxygen-containing gas from the pressurized gas source 335 is added to the partially oxidized mixture at a point downstream of the first oxidation reactor 375. For example, a portion of the oxygen-containing gas may be added to the second oxidation reactor 378, in which the particulate solids catalyst provides further oxidation of one or more undesirable constituents.

Although the reaction zone 360 is shown as containing two separate wet oxidation reactors, 375, 378 in series, the wet oxidation system can include a single oxidation reactor vessel divided into at least two reactor portions by, for example, baffles or partitions. The particulate solids catalyst may then be added to the partially oxidized mixture at a point downstream of the first reactor portion. Likewise, a portion of the oxygen-containing gas from the pressurized gas source 335 may be added to the partially oxidized mixture at a point downstream of the first portion of the partitioned wet oxidation reactor.

Upon leaving the reactor assembly 373 via a conduit 385, the oxidation of the one or more undesirable constituents may be substantially complete and the slurry mixture is designated as the oxidized slurry mixture. The oxidized slurry mixture may be withdrawn from the reaction zone 360 and cooled to a temperature substantially below the elevated temperature of the reaction zone 360. The hot oxidized slurry mixture flows via the conduit 385 through the process heat exchanger 365 that transfers heat from the hot oxidized slurry mixture departing from the contained reaction zone 360 to the aqueous mixture entering reaction zone 360. Additional heaters/heat exchangers may be positioned on conduit 371 through which the partially oxidized aqueous mixture passes from the first wet oxidation reactor 375 to the second wet oxidation reactor 378.

Cooled oxidized slurry mixture may flow via a conduit 390 to a pressure control valve 395 connected to a gas/slurry separation vessel 400. The cooled oxidized slurry mixture is then depressurized via passage of the oxidized mixture through the pressure control valve 395 and into the gas/slurry separation tank 400 to produce an off-gas phase and an oxidized effluent slurry phase containing the catalyst particles. The off-gas phase is vented from the separation tank 400 to the atmosphere or to a further treatment step. The oxidized effluent slurry phase containing the catalyst suspension may be discharged if recovery of the catalyst particles is not desired. The cost of the catalyst particles may be sufficiently inexpensive that recovery is not economically viable.

If recovery of the catalyst particles is desired, either by the high cost of the catalyst particles or discharge is regulated by government agencies, the oxidized effluent slurry phase is transferred via a slurry conduit 405 to a liquid/solids separation tank 410. The oxidized effluent slurry is treated to form a recovered particulate solids catalyst phase and an oxidized effluent liquid phase which is substantially free of particulate solids catalyst. Any conventional separation process may be used. In the embodiment shown in FIG. 3, the catalyst separation treatment includes gravity settling to separate the catalyst particles phase from clear oxidized liquid effluent within the separation tank 410. The liquid effluent is drawn off of the separation tank 410 via an effluent conduit 415. Alternatively, the particulate solids catalyst phase can be separated from oxidized liquid effluent by centrifugical separation, or any other well-known, liquid/solid separation process. The oxidized liquid effluent is substantially free of catalyst particles and can be discharged to the environment or subjected to further treatment, if desired.

At least a portion of the recovered particulate solids catalyst phase may be recycled in order to form additional slurry mixture within the second reactor 378. In FIG. 3, the settled particulate solids catalyst, in the form of a slurry, exits the separation tank 400 through a conduit 425. The settled catalyst is directed to a catalyst recycle pump 430 via a conduit 435 and back to the catalyst feed tank 340 for addition to the pressurized partially oxidized aqueous mixture entering, or within, the second reactor 378. The recycled catalyst may supplement the particulate solids catalyst added to the oxidation aqueous mixture to form a slurry mixture. After initial charging of the catalytic wet oxidation system, sufficient recovered catalyst may be available from the catalyst recycle section to satisfy all the catalyst desired for addition to the partially oxidized aqueous mixture flowing through a conduit 371 and entering the second wet oxidation reactor 378. In another embodiment, the recovered particulate solids catalyst phase may be treated to remove inert solid particulates there from. At least a portion of the treated recovered particulate solids catalyst phase may be recycled in order to form the influent slurry mixture in the second wet oxidation reactor 378.

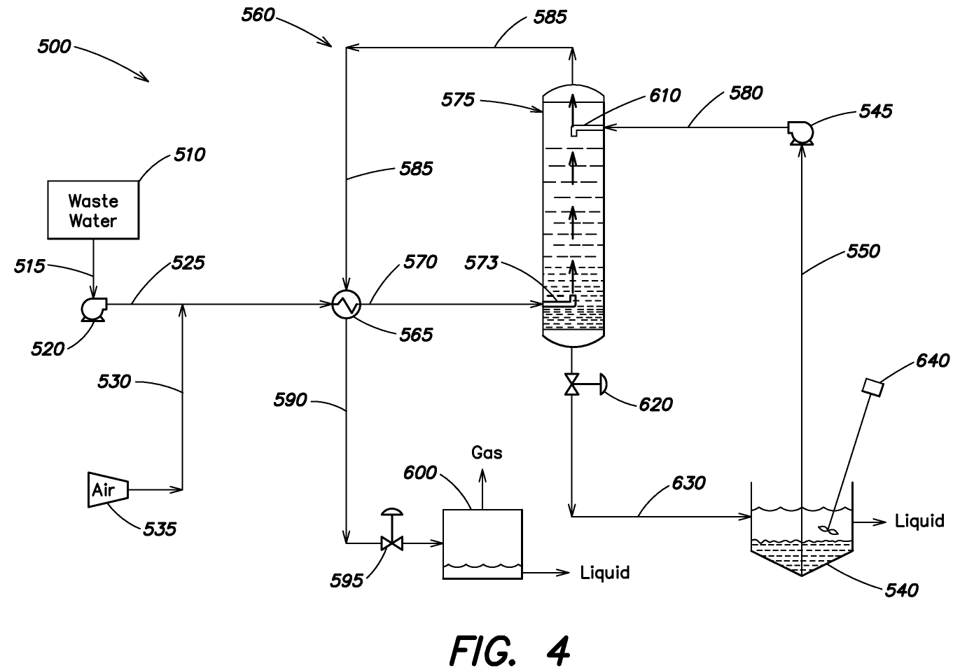

FIG. 4 is a schematic representation of yet another embodiment of a wet oxidation system used for carrying out the process of the present invention is shown. The wet oxidation system 500 includes a feed tank 510 containing the aqueous mixture comprising at least one undesirable constituents to be treated. The aqueous mixture flows through a conduit 515 to a feed pump 520 which delivers the aqueous mixture to the wet oxidation system 500 at system operating pressure. The pressurized aqueous mixture in a conduit 525 is mixed with an oxygen-containing gas from a pressurized gas source 535 delivered by a pressurized gas conduit 530 to form an oxidation aqueous mixture comprising a gas phase and a liquid phase. The oxygen-containing gas includes air, oxygen-enriched air, or essentially pure oxygen gas which may be added to the system at any point prior to and/or during wet oxidation via conventional methods, such as injection.

Following introduction of the oxygen-containing gas from the pressurized gas source 535 in FIG. 4, the oxidation feed mixture is then heated in a reaction zone 560 to an elevated temperature and at a pressure sufficient to maintain a portion of the oxidation feed mixture in the liquid phase, for a time sufficient to oxidize at least a portion of the one or more undesirable constituents therein. In this embodiment, the reaction zone 560 includes a vertically oriented cylindrical wet oxidation reactor 575, which provides the residence time for the bulk of the oxidation of the one or more undesirable constituents in the oxidation aqueous mixture to occur.

Oxidation of the pollutants in the aqueous mixture by oxygen of the oxygen-containing gas is exothermic, thereby raising the temperature in the contained reaction zone 560 to a selected value. In one embodiment, the elevated temperature of the reaction zone is between about 90° C. and about 370° C. The operating pressure of the wet oxidation system 500 is sufficient to maintain a portion of the oxidation aqueous mixture in the liquid phase and prevent the reaction zone 560 from drying out. The operating pressure of the system may range from about 0.3 MPa to about 30 MPa. The partially heated oxidation aqueous mixture flows from the process heat exchanger 565, via a conduit 570, to the vertical oxidation reactor 575, which provides the residence time for the oxidation of the one or more undesirable constituents to occur. The oxidation reactor 575 includes an upwardly oriented, reactor inlet 573 to direct the oxidation feed mixture toward the top of the vertically oriented cylindrical reactor 575.

In order to effect additional destruction of pollutants in the oxidation feed mixture, a slurry of particulate solids catalyst may be added into the upper portion of the vertical oxidation reactor 575 to catalyze further oxidation of the one or more undesirable constituents therein. The particulate solids catalyst is prepared as a slurry in the catalyst feed tank 540. The slurry is added to the pressurized wet oxidation reactor 575 by means of a catalyst pump 545 via a conduit 550 between the tank 540 and the pump 545. The catalyst pump 545 delivers the catalyst to a catalyst inlet 610 via the conduit 580. The particulate solids catalyst are sufficiently heavy to remain within the wet oxidation reactor 575 as the liquid and gas phases move from the bottom to the top thereof. The particulate solids catalyst collects at the bottom of the vertically oriented cylindrical reactor 575 and are periodically removed and routed to the particulate solids catalyst tank 540. A control valve 620 in a catalyst outlet conduit 630 provides intermittent removal of a catalyst particle phase for recycle to the particulate solids catalyst tank 540.

Upon exiting the vertically oriented wet oxidation reactor 575 via a conduit 585, the oxidation of at least one of the undesirable constituents is substantially complete, and the gas/liquid mixture is designated as the oxidized aqueous mixture. The oxidized aqueous mixture is then withdrawn from the reaction zone 560 and cooled to a temperature substantially below the elevated temperature of the reaction zone 560. The hot oxidized aqueous mixture flows via the conduit 585 through a process heat exchanger 565 that transfers heat from the hot oxidized aqueous mixture, departing from the reaction zone 560 to the oxidation aqueous mixture entering the contained reaction zone 560.

The cooled oxidized aqueous mixture then flows via a conduit 590 to a pressure control valve 595 connected to a gas/liquid separation tank 600. The cooled oxidized aqueous mixture is then depressurized via passage of the oxidized mixture through the pressure control valve 595 and into the gas/liquid separation tank 600 to produce an off-gas phase and an oxidized liquid phase, which can be discharged to the environment.

In one example embodiment of the invention, the particulate solids catalyst comprises a combination of at least manganese oxide and cerium oxide. In yet another example, the particulate solids catalyst comprises a combination of at least manganese oxide and cerium oxide in a ratio of about 70:30 mole % Mn:Ce.

In some embodiments, the wet oxidation system may include a controller (not shown) for adjusting or regulating at least one operating parameter of the system or a component of the system, such as, but not limited to, actuating valves and pumps. The controller may be in electronic communication with one or more sensors. The controller may be generally configured to generate a control signal to adjust one or more operating parameters of the wet oxidation system, such as, pressure, temperature, pH levels. In some embodiments, it may be desirable to control the pH of the slurry mixture to ensure the heterogeneous catalyst remains insoluble during wet oxidation. For example, the controller may provide a control signal to one or more valves associated with pH adjuster source (not shown) to add pH adjustor to the aqueous mixture source and or the slurry mixture.

The controller is typically a microprocessor-based device, such as a programmable logic controller (PLC) or a distributed control system, that receives or sends input and output signals to and from components of the wet oxidation system. Communication networks may permit any sensor or signal-generating device to be located at a significant distance from the controller or an associated computer system, while still providing data therebetween. Such communication mechanisms may be effected by utilizing any suitable technique including but not limited to those utilizing wireless protocols.

It should be appreciated that numerous alterations, modifications and improvements may be made to the illustrated systems and methods. For example, one or more wet oxidation systems may be connected to multiple sources of process streams. In some embodiments, the wet oxidation system may include additional sensors for measuring other properties or operating conditions of the system. For example, the system may include sensors for temperature, pressure drop, and flow rate at different points to facilitate system monitoring. In accordance with one or more embodiments, the catalyst may be replenished during the wet oxidation process.

The invention contemplates the modification of existing facilities to retrofit one or more systems or components in order to implement the techniques of the invention. An existing wet oxidation system can be modified in accordance with one or more embodiments exemplarily discussed herein utilizing at least some of the preexisting equipment. For example, one or more pH sensors may be provided and a controller in accordance with one or more embodiments presented herein may be implemented in a preexisting wet oxidation system to promote catalyst solubility.

The function and advantages of these and other embodiments of the present invention will be more fully understood from the following examples. These examples are intended to be illustrative in nature and are not considered to be limiting the scope of the invention. In the following examples, compounds are treated by wet oxidation to affect destruction of bonds therein.

### EXAMPLES

### Preparation of Particulate Solids Catalyst

An aqueous solution of manganese (II) chloride and cerium (III) chloride was prepared by dissolving 25.75 g of MnCl₂.4H₂O and 20.88 g of CeCl₃.7H₂O in 100 ml of deionized water. The resulting metal salts solution was poured into 300 ml of 3M NaOH to precipitate an intimate mixture of Mn(OH)₂ and Ce(OH)₃. The pinkish precipitate was collected by vacuum filtration on a Whatman #1 filter paper. The precipitate darkened on standing and was then washed with six 50 mL portions of deionized water. The precipitate was dried in an oven at 100° C. for four hours and then placed in a crucible and heated in a furnace for three hours at 350° C. The resulting calcined catalyst weighed 14.4 g and was ground to a fine particulate material using a mortar and pestle. Based upon the starting materials, the catalyst was calculated to contain manganese oxide and cerium oxide in a ratio of about 70:30 mole % Mn:Ce.

The catalyst was further characterized by subjecting a sample of the fine particulate material to sieve sizing using standardized screening devices. The size distribution of the particulate solids catalyst material is shown in Table 1 below.

TABLE 1
Sieve Sizing of Mn/Ce Particulate Solids Catalyst

| Sieve Sizing | >100 Mesh | 100-200 Mesh | <200 Mesh |
|---|---|---|---|
| Mesh Opening, mm | >0.150 | 0.150-0.075 | <0.075 |
| Size Distribution, | 33.7 | 20.4 | 45.9 |
| Wgt % | | | |

The particulate solids catalyst material was found to have a particle density of 3.1 g/cm³ and a bulk density of 47.0 lbs/ft³. A bulk sample of the particulate solids catalyst material was evaluated for settling by vigorously mixing a weighed portion of the material with water in a graduated cylinder. After two (2) hours of undisturbed settling, there was a perceptible interface between settled particles and the liquid there above. The liquid was drawn off, and the settled particulate solids catalyst material was colleted, dried and weighed. The settled, particulate solids catalyst material accounted for 92.2% of the total weight of the initial material. The maximum particle size remaining in suspension following the two (2) hour settling test was estimated at 5 microns. Thus, the catalyst particle size may range in size from about 5 microns to about 500 microns to provide suitable settling characteristics for removal from the treated slurry mixture and recycle to a point upstream of the wet oxidation treatment system.

### Bench Scale Wet Oxidation (Autoclave) Reactors

Bench scale wet oxidation tests were performed in laboratory autoclaves. The autoclaves differ from the full scale system in that they are batch reactors, where the full scale unit may be a continuous flow reactor. The autoclaves typically operate at a higher pressure than the full scale unit, as a high charge of air must be added to the autoclave in order to provide sufficient oxygen for the duration of the reaction. The results of the autoclave tests provide an indication of the performance of the wet oxidation technology and are useful for screening operating conditions for the wet oxidation process.

The autoclaves used were fabricated from titanium and mounted in a heater/shaker mechanism. The selection of the autoclave material of construction was based on the composition of the wastewater feed material. The autoclaves selected for use, each have total capacities of 500 ml.

The function and advantages of these and other embodiments of the present invention will be more fully understood from the following examples. These examples are intended to be illustrative in nature and are not considered to be limiting the scope of the invention.

### Example 1

### Catalytic Wet Oxidation of Synthetic Acrylic Acid Wastewater

Bench scale testing of the manganese oxide/cerium oxide particulate solids catalyst for wet oxidation of a synthetic acrylic acid wastewater was performed. The autoclave was charged with 100 mL of the synthetic acrylic acid wastewater and either 5 g/L or 10 g/L of particulate solids Mn/Ce catalyst. A control having no particulate solids Mn/Ce catalyst was also run. The autoclave was then sealed and pressurized with sufficient air to provide oxygen in excess of the Chemical Oxygen Demand (COD) of the synthetic wastewater. Each autoclave was heated to a selected temperatures including 240° C., 260° C. and 280° C., and maintained at the selected temperature for 1.0 hour. The temperature was monitored with a bayonet thermocouple inserted into a thermocouple well, extending interior the autoclave. The heated autoclave was removed from the heater/shaker mechanism and cooled with tap water. The gas phase from the cooled autoclave was analyzed for permanent gases, oxides of carbon, hydrogen, and hydrocarbons by gas chromatography. The autoclave was then opened, and the liquid phase was removed by decanting from the particulate solids catalyst. The liquid phase was then analyzed for COD, Total Organic Carbon (TOC), pH and soluble manganese and cerium. The bench scale testing results are summarized in Table 2 below.

TABLE 2
CATALYTIC WET OXIDATION OF
SYNTHETIC ACRYLIC ACID WASTEWATER FOR 1 HOUR

| Analysis | Feed | No. 1 | No. 2 | No. 3 | No. 4 | No. 5 |
|---|---|---|---|---|---|---|
| Catalyst | — | 0.0 | 5.0 | 10.0 | 5.0 | 5.0 |
| g/L | | | | | | |
| Oxidation | — | 280 | 280 | 280 | 260 | 240 |
| Temp. ° C. | | | | | | |
| COD, | 41,500 | 16,000 | 530 | <87 | 2,350 | 6,810 |
| mg/L | | | | | | |
| COD | — | 61.4 | 98.7 | >99.8 | 94.3 | 83.6 |
| Removal % | | | | | | |
| TOC, | 15,500 | 6,130 | 196 | 80 | 650 | 1,850 |
| mg/L | | | | | | |
| TOC | — | 60.5 | 98.7 | 99.5 | 95.8 | 88.1 |
| Removal % | | | | | | |
| O₂ Uptake, | — | 28,600 | 45,000 | 45,300 | 40,000 | 35,300 |
| mg/L | | | | | | |
| pH | 1.6 | 2.5 | 2.6 | 2.7 | 2.7 | 2.9 |
| Soluble | — | — | — | 220 | — | — |
| Mn, mg/L | | | | | | |
| Soluble | — | — | — | 2.7 | — | — |
| Ce, mg/L | | | | | | |

The addition of the Mn/Ce particulate solids catalyst significantly increased the removal of the acrylic acid in the wastewater as evidenced by the reduction in chemical oxygen demand (COD) and total organic carbon (TOC) when compared to wet oxidation without the catalyst. Specifically, catalytic wet oxidation at 280° C. of the acrylic acid wastewater feed having an initial COD of 41, 500 mg/L reduced the COD to 530 mg/L using 5.0 g/L catalyst and to <87 g/L using 10 g/L catalyst. This 98.7% and a greater than 99.8% reduction in COD, respectively, was significantly higher than the 61.4% reduction resulting from wet oxidation at 280° C. of the acrylic acid wastewater without the use of the Mn/Ce particulate solids catalyst. Similarly, catalytic wet oxidation at 280° C. of the acrylic acid wastewater feed having an initial TOC of 15,500 mg/L reduced the TOC to 196 mg/L using 5.0 g/L catalyst and to 80 g/L using 10 g/L catalyst. This 98.7% and 99.5% reduction in TOC, respectively, was significantly higher than the 60.5% reduction resulting from wet oxidation at 280° C. of the acrylic acid wastewater without the use of the Mn/Ce particulate solids catalyst.

In addition, the use of the Mn/Ce particulate solids catalyst significantly increased the removal of the acrylic acid in the wastewater even at lower temperatures when compared to wet oxidation without the Mn/Ce particulate solids catalyst. Specifically, catalytic wet oxidation at using 5 g/L of the Mn/Ce particulate solids catalyst of the acrylic acid wastewater having an initial COD of 41,500 mg/L reduced the COD to 2,350 mg/L at 260° C. and to 6,810 g/L at 240° C. This 94.3% and 83.6% reduction in COD, respectively, was significantly higher than the 61.4% reduction resulting from wet oxidation at 280° C. of the acrylic acid wastewater without the use of the Mn/Ce particulate solids catalyst. Similarly, catalytic wet oxidation using 5 g/l of the Mn/Ce particulate solids catalyst reduced the TOC to 650 mg/L and 1,850 mg/L at 260° C. and 240° C., respectively. This 95.8% and a 83.1% reduction in TOC, respectively, was significantly higher than the 60.5% reduction resulting from wet oxidation at 280° C. of the acrylic acid wastewater without the use of the Mn/Ce particulate solids catalyst

### Example 2

### Catalytic Wet Oxidation of Aqueous Aliphatic Acids Mixture

Bench scale testing of the manganese oxide/cerium oxide particulate solids catalyst for wet oxidation of an aqueous mixture of aliphatic acids was performed. The autoclave was charged with 150 mL of the aqueous mixture of acetic acid, formic acid and propionic acid, which was adjusted to pH 4.75 with sodium hydroxide. A specific weight (5 g/L) of particulate solids Mn/Ce catalyst was then added to the autoclave. The autoclave was then sealed and pressurized with sufficient air to provide oxygen in excess of the Chemical Oxygen Demand (COD) of the aqueous mixture of aliphatic acids. Each autoclave was heated to a selected temperatures (200° C. and 250° C.) and maintained at the selected temperature for 1.0 hour. The temperature was monitored with a bayonet thermocouple inserted into a thermocouple well, extending interior the autoclave. The heated autoclave was removed from the heater/shaker mechanism and cooled with tap water. The gas phase from the cooled autoclave was analyzed for permanent gases, oxides of carbon, hydrogen, and hydrocarbons by gas chromatography. The autoclave was then opened, and the liquid phase was removed by decanting from the particulate solids catalyst. The liquid phase was then analyzed for COD, pH and individual aliphatic acids. The bench scale testing results are summarized in Table 3 below.

TABLE 3
CATALYTIC WET OXIDATION OF
AQUEOUS ALIPHATIC ACIDS MIXTURE FOR 1 HOUR

| | | Oxidized | | | Acetic | Formic | Propionic |
|---|---|---|---|---|---|---|---|
| Catalyst | Oxidation | Liquid | COD, | % COD | Acid, | Acid, | Acid, |
| Used | Temp, ° C. | pH | mg/L | Removal | mg/L | mg/L | mg/L |
| Feed | — | (4.75) | 8187 | — | 5000 | 6667 | 333 |
| None | 200 | 4.39 | 8033 | 1.9 | 6040 | 540 | <3 |
| None | 250 | 7.21 | 5915 | 27.7 | 4970 | 2030 | <3 |
| Mn/Ce | 200 | 7.10 | 5180 | 36.7 | 5180 | 1520 | <3 |
| Mn/Ce | 250 | 7.76 | 2822 | 65.5 | 2650 | 81 | <3 |

The addition of the Mn/Ce particulate solids catalyst significantly decreased the COD levels in the wastewater as evidenced by the reduction in COD levels when compared to wet oxidation without the catalyst. Specifically, catalytic wet oxidation of the wastewater feed having an initial COD of 8,187 mg/L reduced the COD to 5,180 mg/l at 200° C. and to 2,822 mg/L at 250° C. This 36.7% and 65.5% reduction in COD, respectively, was significantly higher than the 1.9% reduction at 200° C. and the 36.7% reduction at 250° C. wet oxidation at 280° C. of without the use of the Mn/Ce particulate solids catalyst.

### Example 3

### Recycled Catalyst for Wet Oxidation of Synthetic Acrylic Acid Wastewater

Bench scale testing, employing recycling of the manganese oxide/cerium oxide particulate solids catalyst for wet oxidation of a synthetic acrylic acid wastewater, was performed. The autoclave was charged with 100 mL of the synthetic acrylic acid wastewater and a specific weight (10.0 g/L) of particulate solids Mn/Ce catalyst in Run No. 1. The autoclave was then sealed and pressurized with sufficient air to provide oxygen in excess of the Chemical Oxygen Demand (COD) of the synthetic wastewater. Each autoclave was heated to 280° C. and maintained at that temperature for 1.0 hour. The temperature was monitored with a bayonet thermocouple, inserted into a thermocouple well, extending interior the autoclave. The heated autoclave was removed from the heater/shaker mechanism and cooled with tap water. The gas phase from the cooled autoclave was analyzed for permanent gases, oxides of carbon, hydrogen, and hydrocarbons by gas chromatography. The autoclave was then opened, and the liquid phase was removed by decanting from the particulate solids catalyst. The liquid phase was then analyzed for COD, Total Organic Carbon (TOC), pH and soluble manganese and cerium. A portion of the recovered Mn/Ce particulate solids catalyst (5.0 g/L) was then added to an additional 100 mL of the synthetic acrylic acid wastewater and, under identical treatment conditions, the above described process repeated in Run No. 2. The recovered Mn/Ce particulate solids catalyst from Run No. 2 was used successively in Run No. 3. Similarly, the recovered Mn/Ce particulate solids catalyst from Run No. 3 was used successively in Run No. 4. The bench scale testing results are summarized in Table 4 below.

TABLE 4
RECYCLED CATALYST FOR WET OXIDATION
OF SYNTHETIC ACRYLIC ACID WASTEWATER
FOR 1 HOUR AT 280° C.

| Analysis | Feed | Run No. 1 | Run No. 2 | Run No. 3 | Run No. 4 |
|---|---|---|---|---|---|
| Catalyst, g/L | — | 10.0 | 5.0 | 5.0 | 5.0 |
| COD, mg/L | 42,400 | 323 | 376 | 410 | 507 |
| COD | — | 99.2 | 99.1 | 99.0 | 98.8 |
| Removal, % | | | | | |
| TOC, mg/L | 14,100 | 95 | 112 | 103 | 132 |
| TOC | — | 99.3 | 99.2 | 99.3 | 99.1 |
| Removal, % | | | | | |
| O₂ Uptake, | — | 43,600 | 43,700 | 43,100 | 43,900 |
| mg/L | | | | | |
| pH | 1.5 | 2.8 | 3.7 | 4.0 | 4.1 |
| Soluble Mn, | — | 222 | 13.2 | 23.5 | 35.6 |
| mg/L | | | | | |
| Soluble Ce, | — | <2.0 | <2.0 | <5.0 | <5.0 |
| mg/L | | | | | |

The bench scale testing described above demonstrates the effectiveness of the manganese oxide/cerium oxide particulate solids catalyst when recycled to treat additional amounts of a wastewater resistant to wet oxidation treatment. Specifically, the virgin catalyst exhibited a 99.2% reduction in COD and the three successive uses of the recovered catalyst resulted in 99.1%, 99.0% and 98.8% reductions in COD, respectively. Similarly, the virgin catalyst exhibited a 99.3% reduction in TOC and the three successive uses of the recovered catalyst resulted in 99.2%, 99.3% and 99.1 5 reduction in TOC. The successive reuse of the catalyst did not appreciably degrade its effectiveness.

### Example 4

### Catalytic Wet Oxidation of Aqueous Ammonium Sulfate Solution

Bench scale testing of the manganese oxide/cerium oxide particulate solids catalyst for wet oxidation of a synthetic ammonia-containing wastewater was performed. The autoclave was charged with 150 mL of a solution containing 20.0 g/L of ammonium sulfate and 5.0 g/L of particulate solids Mn/Ce catalyst. In one test, the aqueous solution also contained 12.1 g/L of sodium hydroxide to examine the effect of alkaline conditions. The autoclave was then sealed and pressurized with an oxygen/helium mixture to provide oxygen in excess of the Chemical Oxygen Demand (COD) of the ammonia-containing wastewater. The oxygen/helium mixture allowed the detection of nitrogen in the gas phase following catalytic wet oxidation testing. Each autoclave was heated to 280° C. and maintained at temperature for 1.0 hour. The temperature was monitored with a bayonet thermocouple inserted into a thermocouple well, extending interior the autoclave. The heated autoclave was removed from the heater/shaker mechanism and cooled with tap water. The gas phase from the cooled autoclave was analyzed for permanent gases, oxides of carbon, hydrogen, and hydrocarbons by gas chromatography. The autoclave was then opened, and the liquid phase was removed by decanting from the particulate solids catalyst. The liquid phase was then analyzed for ammonia-nitrogen, pH and soluble manganese and cerium. The bench scale testing results are summarized in Table 5 below.

TABLE 5
CATALYTIC WET OXIDATION OF AQUEOUS AMMONIUM
SULFATE SOLUTION FOR 1 HOUR AT 280° C.

| Analysis | Feed No. 1 | Run No. 1 | Feed No. 2 | Run No. 2 |
|---|---|---|---|---|
| Mn/Ce Catalyst, | — | 5.0 | — | 5.0 |
| g/L | | | | |
| NH₃—N, | 4,570 | 1,540 | 4,010 | 2,290 |
| mg/L | | | | |
| NH₃—N | — | 66.3 | — | 42.9 |
| Removal, % | | | | |
| O₂ Uptake, | — | 8,700 | — | 3,200 |
| mg/L | | | | |
| pH | — | 10.4 | — | 2.2 |
| Soluble Mn, | — | <0.02 | — | 47 |
| mg/L | | | | |
| Soluble Ce, | — | <5.0 | — | <5.0 |
| mg/L | | | | |

As noted above, the manganese oxide/cerium oxide particulate solids catalyst was effective in oxidizing ammonia resulting in a 66.3% and 42.9 5% reduction in NH₃—N at a pH of 10.4 and 2.2 respectively. Not wishing to be bound by any particular theory, it may be that the catalyst was less effective at the acidic pH because a portion of the catalysts was soluble as evidenced by the higher soluble content of Mn (47 mg/L) compared to the soluble content of Mn (<0.02) at a pH of 10.4. Regardless of the pH, the manganese oxide/cerium oxide particulate solids catalyst was effective in oxidizing the ammonia under wet oxidations conditions at which ammonia is typically resistant to oxidation in the absence of such a catalyst.

### Example 5

### Catalytic Wet Oxidation of Aqueous Ammonium Sulfate Solution

Bench scale testing of platinum impregnated activated carbon particulate solids catalyst for wet oxidation of a synthetic ammonia-containing wastewater was performed. The autoclave was charged with 150 mL of a solution containing 20.0 g/L of ammonium sulfate and 5.0 g/L of particulate solids Pt-on-carbon catalyst. The aqueous solution also contained 12.1 g/L of sodium hydroxide to provide alkaline conditions during the wet oxidation tests. The autoclave was then sealed and pressurized with an oxygen/helium mixture to provide oxygen in excess of the Chemical Oxygen Demand (COD) of the ammonia-containing wastewater. Each autoclave was heated to 280° C. and maintained at temperature for 1.0 hour. The temperature was monitored with a bayonet thermocouple, inserted into a thermocouple well, extending interior the autoclave. The heated autoclave was removed from the heater/shaker mechanism and cooled with tap water. The gas phase from the cooled autoclave was analyzed for permanent gases, oxides of carbon, hydrogen, and hydrocarbons by gas chromatography. The autoclave was then opened, and the liquid phase was removed by decanting from the particulate solids catalyst. The liquid phase was then analyzed for ammonia-nitrogen, pH and soluble platinum. As a basis for comparison, one test run was performed without the addition of the Pt-on-carbon particulate solids catalyst. The bench scale testing results are summarized in Table 6 below.

TABLE 6
CATALYTIC WET OXIDATION OF AQUEOUS AMMONIUM
SULFATE SOLUTION FOR 1 HOUR AT 280° C.

| Analysis | Feed | Run No. 1 | Run No. 2 |
|---|---|---|---|
| Pt/C Catalyst, g/L | — | 0.0 | 5.0 |
| NH₃—N, | 4,060 | 3,730 | 30 |
| mg/L | | | |
| NH₃—N | — | 8.1 | 99.3 |
| Removal, % | | | |
| O₂ Uptake, | — | 4,500 | 10,800 |
| mg/L | | | |
| pH | 11.6 | 11.4 | 11.4 |
| Soluble Pt, | — | <0.5 | <0.5 |
| mg/L | | | |

The bench scale testing, described above, demonstrates the effectiveness of the platinum-on-carbon particulate solids catalyst on the oxidation of ammonia under wet oxidations conditions at which ammonia is resistant to oxidation in the absence of such a catalyst. The content of NH₃—N was reduced by 99.3% when the catalyst was used in comparison to only an 8.1% reduction without the catalyst.

### Example 6

### Catalytic Wet Oxidation using a Nanometer Size Catalyst

Bench scale testing of a cerium oxide nanometers size particulate solids catalyst for wet oxidation of acetic acid using 500 mL capacity titanium autoclaves mounted in a heater/shaker mechanism. The autoclave was charged with 150 mL of a the acetic acid solution and a specific weight of catalyst (150 mg/L). The catalyst was NanoTek® CE-6042, an 18% cerium (IV) oxide colloidal dispersion in water obtained from Alfa Aesar of Ward Hill Mass., USA.

The autoclave was then sealed and pressurized with sufficient air to provide oxygen in excess of the Chemical Oxygen Demand (COD) of the acetic acid solution. A control wet oxidation run was also made without the addition of the catalyst. Each autoclave was heated to 280° C. and maintained at temperature for 1.0 hour. The temperature was monitored with a bayonet thermocouple inserted into a thermocouple well, extending interior the autoclave. The heated autoclave was removed from the heater/shaker mechanism and cooled with tap water. The gas phase from the cooled autoclave was analyzed for its concentration of oxygen by gas chromatography. The autoclave was then opened, and the liquid phase was removed by decanting from the particulate solids catalyst. The liquid phase was then analyzed for COD and pH. The bench scale testing results are summarized in Table 7 below.

TABLE 7
CATALYTIC WET OXIDATION OF AN ACETIC ACID USING
A NANOMETER SIZE CERIUM OXIDE CATALYST

| | No Catalyst | Catalytic Wet Oxidation |
|---|---|---|
| Catalyst Added, mg/L | — | 150 |
| Oxidation Temp., ° C. | 280 | 280 |
| COD of Feed, Mg/L | 10,800 | 10,500 |
| COD of Oxidized Effluent, | 10,100 | 8,800 |
| mg/L | | |
| COD Removal, % | 6.5 | 17.8 |
| TOC of Feed, Mg/L | 3,790 | 4,460 |
| TOC Removal, % | 2.1 | 16.4 |
| Soluble Ce | — | <5.0 |

The nanometer sized cerium oxide catalyst was effective in oxidizing acetic acid under conditions at which the acetic acid is typically resistant to wet oxidation treatment. The presence of the nanometer size cerium oxide catalyst reduced the COD by 17.8% compared to only a 6.5% reduction without the catalyst.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

What is claimed is:

1. A catalytic wet oxidation process, comprising:
providing an aqueous mixture containing at least one undesirable constituent to be treated;
contacting the aqueous mixture with a particulate solids catalyst to form a slurry mixture comprising the at least one undesirable constituent to be treated and the particulate solids catalyst;
treating the slurry mixture at a subcritical temperature and a superatmospheric pressure to oxidize the at least one undesirable constituent and form an oxidized slurry mixture; and
separating at least a portion of the particulate solids catalyst from the oxidized slurry mixture.

2. The process of claim 1, wherein contacting the aqueous mixture with a particulate solids catalyst comprises contacting the aqueous mixture with the particulate solids catalyst in a wet oxidation unit.

3. The process of claim 1, wherein contacting the aqueous mixture with the particulate solids catalyst comprises contacting the aqueous mixture with the particulate solids catalyst prior to entering a wet oxidation unit.

4. The process of any one of claims 2 and 3, wherein the wet oxidation unit comprises at least two reactor portions.

5. The process of claim 1, wherein separating the particulate solids catalyst from the oxidized slurry mixture comprises separating the oxidized slurry into a gas phase, an oxidized liquid phase, and a particulate solids catalyst phase essentially simultaneously in a separation zone.

6. The process of claim 1, wherein separating the particulate solids catalyst from the oxidized slurry mixture comprises separating the oxidized slurry into a gas phase, an oxidized liquid phase, and a particulate solids catalyst phase in multiple separation zones.

7. The process of claim 2, wherein separating the particulate solids catalyst from the oxidized slurry mixture comprises separating the particulate catalyst phase from the oxidized slurry phase in the wet oxidation unit.

8. The process of claim 7, wherein separating the particulate catalyst phase from the oxidized slurry phase in the wet oxidation unit comprises directing flow of the particulate solids catalyst in a direction counter to a flow of the aqueous mixture.

9. The process of claim 8, wherein directing the flow of the particulate solids catalyst comprises directing the flow of the particulate solids catalyst downward in a vertically oriented wet oxidation unit.

10. The process of claim 1, wherein contacting the aqueous mixture with the particulate solids catalyst comprises contacting the aqueous mixture with at least a portion of the particulate solids catalyst separated from the oxidized slurry mixture.

11. The process of claim 10, further comprising removing inert solids from at least a portion of the particulate solids catalyst prior to contacting the aqueous mixture with at least a portion of the particulate solids catalyst.

12. The process of claim 1, wherein contacting the aqueous mixture with the particulate solids catalyst comprises contacting the aqueous mixture with a particulate solids catalyst selected from the group consisting of a transition metal element and water insoluble compounds thereof.

13. The process of claim 12, wherein contacting the aqueous mixture with the particulate solids catalyst comprises contacting the aqueous mixture with a mixture of at least two transition metal elements including water insoluble compounds thereof.

14. The process of claim 12, wherein contacting the aqueous mixture with the particulate solids catalyst comprises contacting the aqueous mixture with a mixture of at least manganese oxide and cerium oxide.

15. The process of claim 1, wherein contacting the aqueous mixture with a particulate solids catalyst comprises contacting the aqueous mixture with a particulate solids catalyst having a particle size ranging from about 5 microns to about 500 microns.

16. The process of claim 1, wherein contacting the aqueous mixture with a particulate solids catalyst comprises contacting the aqueous mixture with particulate solids catalyst having a particle size ranging from about 3 nm to about 15 nm.

17. The process of claim 1, wherein providing the aqueous mixture comprises providing an aqueous stream comprising at least one compound selected from the group consisting of an organic acid, a phenolic compound, an organic halogen compound, a nitrogen-containing compound and a sulfur containing compound.

18. The process of 1, wherein contacting the aqueous mixture with a particulate solids catalyst comprises contacting the aqueous mixture with an aqueous slurry of the particulate solids catalyst.

19. A catalytic wet oxidation system, comprising:
a wet oxidation unit;
a source of an aqueous mixture comprising at least one undesirable constituent fluidly connected to a feed inlet of the wet oxidation unit;
an aqueous mixture conduit comprising:
an inlet fluidly connected to an outlet of the source of the aqueous mixture; and
an outlet fluidly connected to the feed inlet of the wet oxidation unit;
a source of particulate solids catalyst, insoluble in the aqueous mixture, fluidly connected to at least one of a catalyst inlet of the wet oxidation unit, the source of the aqueous mixture, and the aqueous mixture conduit; and
a separator comprising an inlet fluidly connected to an outlet of the wet oxidation unit and a catalyst slurry outlet fluidly connected to at least one of the catalyst inlet of the wet oxidation unit, the source of the aqueous mixture, and the aqueous mixture conduit.

20. The wet oxidation system of claim 19, wherein the feed inlet to the wet oxidation unit and the catalyst inlet to the wet oxidation unit are the same inlet.

21. The wet oxidation system of claim 19, wherein the wet oxidation unit comprises:
a first reactor portion fluidly connected to the feed inlet;
a second reactor portion fluidly connected the catalyst inlet and to an outlet of the first reactor portion.

22. The wet oxidation system of claim 20, wherein the source of particulate solids catalyst is fluidly connected to the catalyst inlet of the wet oxidation unit, and wherein the wet oxidation unit is a first wet oxidation unit, the system further comprising;
a second wet oxidation unit comprising;
an inlet fluidly connected to the aqueous mixture conduit; and
an outlet fluidly connected to the feed inlet of the first wet oxidation unit.

23. The wet oxidation system of claim 22, wherein the catalyst slurry outlet of the separator is fluidly connected to the catalyst inlet to the first wet oxidation unit.

24. The wet oxidation system of claim 22, wherein the feed inlet to the first wet oxidation unit and the catalyst inlet to the first wet oxidation unit are the same inlet.

25. The wet oxidation system of claim 19, wherein the source of particulate solids catalyst comprises a particulate solids catalyst selected from the group consisting of a transition metal element and water insoluble compounds thereof.

26. The wet oxidation system of claim 25, wherein the particulate solids catalyst comprises at least two transition metal elements including water insoluble compounds thereof

27. The wet oxidation system of claim 26, wherein the at least two transition metals are manganese oxide and cerium oxide.

28. The wet oxidation system of claim 19, wherein the particulate solids catalyst comprises a particulate solids catalyst having a particle size ranging from about 5 microns to about 500 microns.

29. The wet oxidation system of claim 19, wherein the particulate solids catalyst comprises a particulate solids catalyst having a particle size ranging from about 3 nm to about 15 nm.

30. The wet oxidation system of claim 19, wherein the source of the aqueous mixture comprises at least one compound selected from the group consisting of an organic acid, a phenolic compound, an organic halogen compound, a nitrogen-containing compound and a sulfur containing compound.
